(19) United States
(12) Patent Application Publication
(10) Pub. No.: US 2026/0180136 A1
(43) Pub. Date: Jun. 25, 2026

(54) ENERGY STORAGE DEVICE

(71) Applicant: Prime Planet Energy & Solutions, Inc., Tokyo (JP)

(72) Inventor: Shuhei TAKESHITA, Nagakute-shi (JP)

(21) Appl. No.: 19/426,056

(22) Filed: Dec. 19, 2025

(30) Foreign Application Priority Data
Dec. 24, 2024 (JP) 2024-227222

(51) Int. Cl. H01M 50/533

(52) U.S. Cl. CPC H01M 50/533

(57) ABSTRACT

Provide is a technique to enhance a current collecting efficiency of a first electrode of an energy storage device. The herein disclosed energy storage device includes a first electrode including a first current collector and a first active material layer provided on the first current collector, includes a second electrode, includes a separator, and includes an electrically conductive layer. The electrically conductive layer is provided between the first active material layer and the separator so as to be arranged over a portion from a surface of the first active material layer to the first current collector.

### CROSS REFERENCE TO RELATED APPLICATIONS

The present application claims the priority based on Japanese Patent Application No. 2024-227222 filed on Dec. 24, 2024, the entire contents of which are incorporated in the present specification by reference.

### BACKGROUND OF THE DISCLOSURE

### 1. Technical Field

A present disclosure relates to an energy storage device.

### 2. Background

As an energy storage device, it is possible to consider a secondary battery, such as lithium ion secondary battery. Recently, this kind of secondary battery is suitably used for a portable power supply of a personal computer, a portable terminal, or the like, a power supply to drive an automobile, such as battery electric vehicle (BEV), hybrid electric vehicle (HEV), and plug-in hybrid electric vehicle (PHEV), or the like.

Regarding a positive electrode for a nonaqueous electrolyte secondary battery disclosed in Japanese Patent Application Publication No. 2018-055836, a positive electrode active material layer is formed in which a surface of a current collector contains a positive electrode active material. A thickness of the positive electrode active material layer is 150 to 1500 μm. At least a part of a surface of the positive electrode active material is covered by a coating agent that contains a covering resin and a conductive assistant agent. A void rate of the positive electrode active material layer is 35.0 to 50.0%, and a density is 2.1 to 3.0 g/cm³. This publication describes that, regarding the nonaqueous electrolyte secondary battery that includes the positive electrode active material layer including the above described configuration, it is possible to enhance an output characteristic at a high rate.

Japanese Patent Application Publication No. 2023-027096 discloses a fine porous membrane or a base material, in which a layer of polycrystalline metal and/or metal oxide is contained on at least one side of a polymer porous membrane. The layer is deposited by a deposition method. This publication describes that a modified membrane can obtain an improved impedance/electrical-charge-transfer, an insulation destroy, and/or an improved safe property.

Japanese Patent Application Publication No. 2012-043629 discloses a separator that is used for a nonaqueous type electrolytic solution secondary battery. The separator includes an electrically conductive layer. An apparent volume resistance rate of the electrically conductive layer is 1×10⁻⁴ Ω·cm to 1×10⁶ Ω·cm. A meltdown temperature of the separator is equal to or more than 170° C. This publication describes that, by the above described configuration, it is possible to enhance the safe property of the nonaqueous type electrolytic solution secondary battery.

A battery separator disclosed in Japanese Patent Application Publication No. 2008-084866 includes a separator and an electrically conductive layer that is disposed on this separator, and by applying it to make the electrically conductive layer come into contact with an electrode, it is possible to provide new routes of electrical current from the electrode and to the electrode. This publication describes that, by the above described configuration, it is possible to enhance a cycle life of the battery.

In a lithium ion secondary battery disclosed by Japanese Patent Application Publication No. 2011-222215, a separator includes a resin layer and a porous metal layer that is imparted on one of its surfaces, and the metal layer is arranged to be opposed to the negative electrode. This publication describes that, by the above described configuration, it is possible to reduce an amount of a metal lithium precipitated by a high rate electrical charge and thus it is possible to implement a superior high rate electrical charge and discharge characteristic.

### SUMMARY

The present inventor thinks to enhance a current collecting efficiency of the electrode.

A herein disclosed energy storage device includes a first electrode including a first current collector and a first active material layer provided on the first current collector, includes a second electrode, includes a separator, and includes an electrically conductive layer. The electrically conductive layer is provided between the first active material layer and the separator so as to be arranged over a portion from a surface of the first active material layer to the first current collector. By the above described configuration, it is possible to enhance the current collecting efficiency of the first electrode.

### BRIEF DESCRIPTION OF THE DRAWINGS

FIG. 1 is a schematic perspective view of an energy storage device 100.

FIG. 2 is an II-II cross section view of FIG. 1.

FIG. 3 is a schematic view of an electrode assembly 20.

FIG. 4 is a partial cross section view of the electrode assembly 20.

FIG. 5 is a partial cross section view of an electrode assembly 220.

### DESCRIPTION OF THE EMBODIMENTS

Below, one embodiment of a herein disclosed energy storage device will be explained. The embodiment explained herein is not to particularly restrict the herein disclosed technique. The herein disclosed technique is not restricted to the embodiment explained herein, unless specifically mentioned. Drawings are schematically illustrated, and thus are not always to reflect actual things. The members/parts providing the same effect are suitably provided with the same numerals and signs, and overlapping explanations might be omitted. A wording “A to B” representing a numerical range not only means “equal to or more than A and not more than B” unless specifically mentioned, but also semantically covers a meaning of “more than A and less than B”.

In the present specification, a term “energy storage device” represents a device in which an electrical charge and an electrical discharge are generated in response to movement of an electrical charge carrier between a pair of electrodes (a positive electrode and a negative electrode) through an electrolyte. The energy storage device semantically covers a secondary battery, such as lithium ion secondary battery; and a capacitor, such as lithium ion capacitor and electric double layer capacitor. Below, an embodiment will be described in a situation where the energy storage device is the lithium ion secondary battery.

### First Embodiment

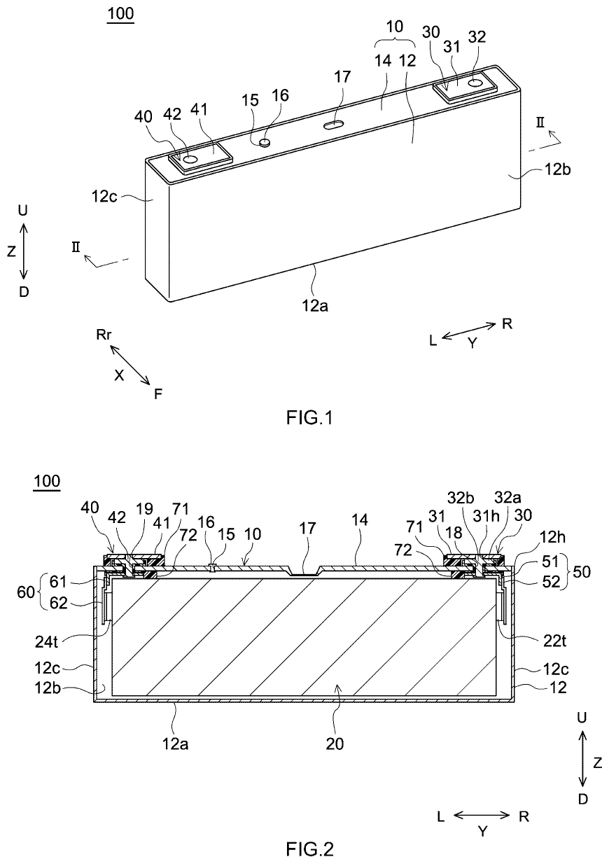

FIG. 1 is a schematic perspective view of an energy storage device 100. FIG. 2 is an II-II cross section view of FIG. 1. As shown in FIG. 1 and FIG. 2, the energy storage device 100 includes a case 10, an electrode assembly 20, a positive electrode terminal 30, a negative electrode terminal 40, a positive electrode current collector member 50, a negative electrode current collector member 60, various insulating members, and a nonaqueous electrolytic solution (not shown in drawings).

The case 10 is an outer container that is configured to accommodate the electrode assembly 20 and the nonaqueous electrolytic solution. The case 10 herein is a case formed in a flat square shape. A material configuring the case 10 is not particularly restricted, and, for example, it is good to suitably use a material configuring the case included by this type of energy storage device.

As shown in FIG. 1 and FIG. 2, the case 10 includes a body 12 and a sealing plate 14. The body 12 includes a bottom surface 12a, a pair of first side surfaces 12b opposed to each other, and a pair of second side surfaces 12c opposed to each other. The bottom surface 12a is formed in a rectangular shape. As shown in FIG. 2, a part opposed to the bottom surface 12a is configured to be an opening 12h. The pair of opposed first side surfaces 12b are formed in rectangular shapes, and are configured to extend from a pair of opposed long sides of the bottom surface 12a. The pair of opposed second side surfaces 12c are formed in rectangular shapes, and are configured to extend from a pair of opposed short edges of the bottom surface 12a. In this embodiment, area sizes of the pair of opposed first side surfaces 12b are larger than area sizes of the pair of opposed second side surfaces 12c.

As shown in FIG. 1 and FIG. 2, the sealing plate 14 is formed in a rectangular flat plate shape, which corresponds to the opening 12h. The sealing plate 14 herein includes a liquid injection hole 15, a safe valve 17, a first terminal install hole 18, and a second terminal install hole 19. The liquid injection hole 15 is a portion through which the nonaqueous electrolytic solution is injected into the case 10. As shown in FIG. 1 and FIG. 2, the liquid injection hole 15 is sealed by a sealing member 16. The safe valve 17 is, for example, a thin-walled part that is set to release an internal pressure of the case 10, when the internal pressure is increased to a level being equal to or more than a predetermined level. The first terminal install hole 18 herein is a penetration hole on which the positive electrode terminal 30 is attached. The second terminal install hole 19 herein is a penetration hole on which the negative electrode terminal 40 is attached. The sealing plate 14 is configured to cover the opening 12h and welded to the body 12 (for example, by laser welding).

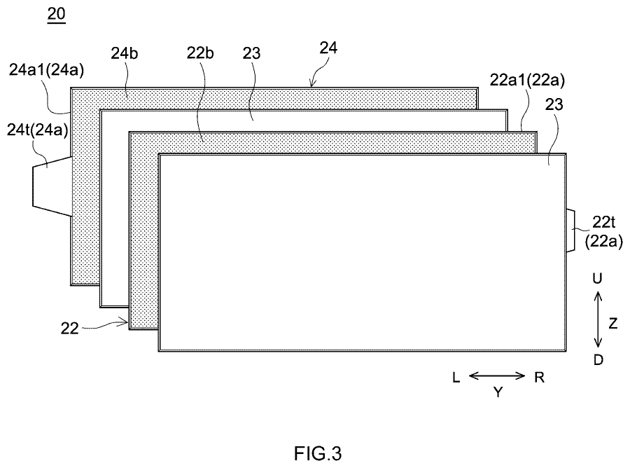

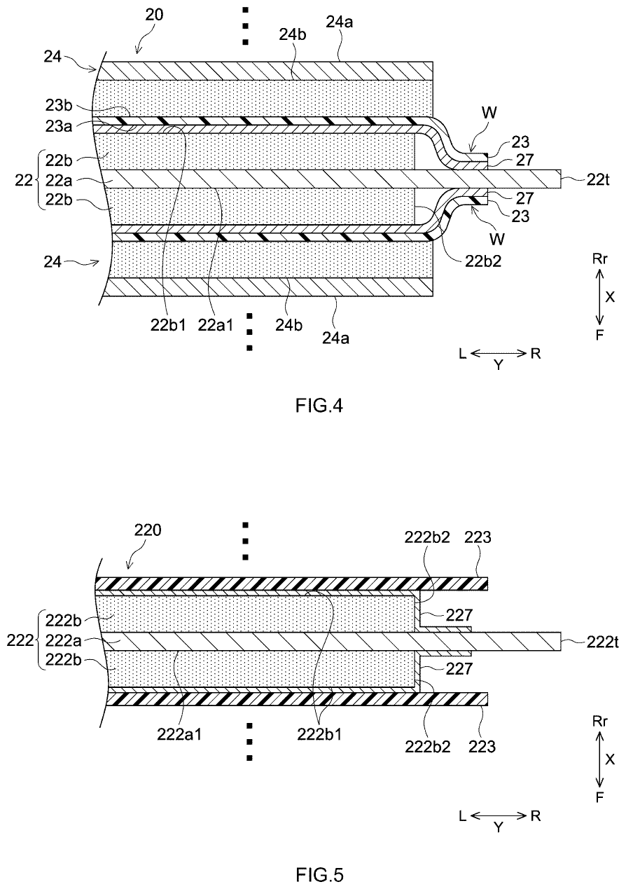

The electrode assembly 20 is a power generating element of the energy storage device 100. FIG. 3 is a schematic view of the electrode assembly 20. FIG. 4 is a partial cross section view of the electrode assembly 20. FIG. 4 schematically shows a laminate structure of the electrode at a vicinity of a positive electrode tab 22t of the electrode assembly 20. As shown in FIG. 3 and FIG. 4, the electrode assembly 20 is a laminate electrode assembly that includes a positive electrode 22 formed in a sheet shape, a negative electrode 24 formed in a sheet shape, and a separator 23 formed in a sheet shape. In the electrode assembly 20, the positive electrode 22 and the negative electrode 24 are superimposed while the separator 23 is disposed between them. In the electrode assembly 20, a number of the positive electrodes 22, a number of the negative electrodes 24, a number of the separators 23 can be suitably set in accordance with a capability desired for the energy storage device 100, or the like. Incidentally, the positive electrode 22 is an example of a first electrode of the herein disclosed energy storage device. The negative electrode 24 is an example of a second electrode of a herein disclosed energy storage device.

As shown in FIG. 3 and FIG. 4, the positive electrode 22 includes a positive electrode current collector 22a formed in a sheet shape, and a positive electrode active material layer 22b. The positive electrode current collector 22a includes a body part 22al that is formed in a rectangular sheet shape, and includes a positive electrode tab 22t. In this embodiment, the positive electrode active material layer 22b is provided on the body part 22al of the positive electrode current collector 22a. The positive electrode active material layer 22b is provided on a surface (here, both surfaces) of the body part 22a1 of the positive electrode current collector 22a. As shown in FIG. 3, the positive electrode tab 22t is configured to protrude outwardly from one of a pair of opposed short edges of the body part 22al. The positive electrode tab 22t is an exposed part of the positive electrode current collector 22a on which the positive electrode active material layer 22b is not provided. The positive electrode current collector 22a is, for example, an aluminum foil.

The positive electrode active material layer 22b contains, for example, a positive electrode active material. The positive electrode active material is not particularly restricted insofar as an effect of the herein disclosed technique is implemented, and thus it is possible to use a positive electrode active material that is used for this kind of purpose and that has a conventionally known composition. It is good that the positive electrode active material is, for example, a lithium composite oxide, a lithium transition metal phosphate compound, or the like. A crystal structure of the positive electrode active material is not particularly restricted, and might be a layered structure, a spinel structure, an olivine structure, or the like.

Regarding the lithium composite oxide, it is preferable to be a lithium-transition metal complex oxide that contains at least 1 kind among Ni, Co, and Mn, as a transition metal element. As the lithium-transition metal complex oxide, for example, it is possible to use a lithium nickel base composite oxide, a lithium cobalt base composite oxide, a lithium manganese base composite oxide, a lithium nickel manganese base composite oxide, a lithium nickel cobalt manganese base composite oxide, a lithium nickel cobalt aluminum base composite oxide, a lithium iron nickel manganese base composite oxide, or the like. Regarding these positive electrode active materials, one kind might be used alone, or two or more kinds might be mixed so as to be used.

Incidentally, the term “lithium nickel cobalt manganese base composite oxide” in the present description is a term semantically covering not only the oxide whose constituent element is Li, Ni, Co, Mn, or O, but also an oxide containing 1 kind, 2 kinds, or more kinds of additive elements other than them. As an additive element, for example, it is possible to use a transition metal element, such as Mg, Ca, Al, Ti, V, Cr, Y, Zr, Nb, Mo, Hf, Ta, W, Na, Fe, Zn, and Sn, a typical metal element, or the like. The additive element might be a semimetal element, such as B, C, Si, and P; or a non-metal element, such as S, F, Cl, Br, and I. This matter is similar even on the above described lithium nickel base composite oxide, lithium cobalt base composite oxide, lithium manganese base composite oxide, lithium nickel manganese base composite oxide, lithium nickel cobalt aluminum base composite oxide, lithium iron nickel manganese base composite oxide, or the like.

As the lithium transition metal phosphate compound, it is possible to use, for example, lithium iron phosphate (LiFePO₄), lithium manganese phosphate (LiMnPO₄), lithium manganese iron phosphate, or the like. As the positive electrode active material, for example, it is possible to preferably use LiNi_{0.33}Co_{0.33}Mn_{0.33}O₂, LiNi_{0.5}Co_{0.2}Mn_{0.3}O₂, LiNi_{0.6}Co_{0.2}Mn_{0.2}O₂, LiNi_{0.8}Co_{0.1}Mn_{0.1}O₂, LiNiO₂, LiCoO₂, LiFeO₂, LiMn₂O₄, LiNi_{0.5}Mn_{1.5}O₄, or the like.

The positive electrode active material layer 22b might contain an electrically conducting material, a binder, or the like, except for the positive electrode active material. As the electrically conducting material, it is possible to use, for example, a carbon black, such as acetylene black (AB); and the other carbon material, such as graphite. As the binder, it is possible to use, for example, polyvinylidene fluoride (PVdF), or the like. A content amount of the positive electrode active material with respect to a whole of the positive electrode active material layer 22b is, for example, preferably equal to or more than 70 mass %, further preferably 80 mass % to 98 mass %, or furthermore preferably 85 mass % to 95 mass %. A content amount of the electrically conducting material with respect to the whole of the positive electrode active material layer 22b is, for example, 0.1 mass % to 20 mass %. A content amount of the binder with respect to the whole of the positive electrode active material layer 22b is, for example, 0.5 mass % to 15 mass %.

As shown in FIG. 3 and FIG. 4, the negative electrode 24 includes a negative electrode current collector 24a formed in a sheet shape, and includes a negative electrode active material layer 24b. The negative electrode current collector 24a includes a body part 24al formed in a rectangular sheet shape, and includes a negative electrode tab 24t. In this embodiment, the negative electrode active material layer 24b is provided on the body part 24al of the negative electrode current collector 24a. The negative electrode active material layer 24b is provided on a surface (here, on both surfaces) of the body part 24al of the negative electrode current collector 24a. In this embodiment, the negative electrode tab 24t is configured to protrude outwardly from one of a pair of opposed short edges of the body part 24al. The negative electrode tab 24t is an exposed part of the negative electrode current collector 24a on which the negative electrode active material layer 24b is not provided. The negative electrode current collector 24a is, for example, a copper foil.

The negative electrode active material layer 24b contains, for example, a negative electrode active material. As the negative electrode active material, for example, it is possible to use a carbon material, such as natural graphite and artificial graphite; a silicon; or the like. The negative electrode active material layer 24b might contain, for example, a binder, a thickening agent, or the like, except for the negative electrode active material. As the binder, it is possible to use, for example, a styrene butadiene rubber (SBR), or the like. As the thickening agent, it is possible to use, for example, carboxymethyl cellulose (CMC), or the like. A content amount of the negative electrode active material with respect to a whole of the negative electrode active material layer 24b is, for example, equal to or more than 70 mass %, preferably equal to or more than 80 mass %, or further preferably 90 mass % to 99 mass %, or might be 95 mass % to 99 mass %. A content amount of the binder with respect to the whole of the negative electrode active material layer 24b is, for example, 0.5 mass % to 10 mass %.

The separator 23 herein is configured to separate the positive electrode 22 and the negative electrode 24. In this embodiment, the separator 23 is formed in a rectangular sheet shape, and is configured to cover the positive electrode active material layer 22b and cover a part of the positive electrode tab 22t. As shown in FIG. 4, the separator 23 is configured to cover an end face 22b1 of the positive electrode active material layer 22b in a thickness direction. In a form shown by FIG. 4, the separator 23 is joined to the positive electrode tab 22t (a joint part W). As a joining means, for example, an ultrasonic welding is preferably used.

Incidentally, although not particularly restricting, from a perspective of making the electrically conductive layer 27 easily come into contact with a side surface 22b2 of the positive electrode active material layer 22b in the thickness direction in addition to the end face 22b1 of the positive electrode active material layer 22b, and from a perspective of enhancing a permeability of the electrolytic solution on the separator 23 on which the electrically conductive layer 27 is provided, or the like, a thickness of the separator 23 is preferably 5 μm to 50 μm, or further preferably 10 μm to 30 μm. From a similar perspective, an air permeability of the separator 23 obtained by Gurley test is preferably equal to or less than 350 second/100 cc, which is not particularly restricted.

As the separator 23, it is possible to use, for example, a porous sheet (film) consisting of a resin material, such as polyethylene (PE), polypropylene (PP), polyester, cellulose, and polyamide. The porous sheet being as the separator 23 might have a single layer structure, or might have two or more layers laminate structure (for example, a three layers structure in which PP layers are laminated on both surfaces of a PE layer).

As shown in FIG. 4, the electrically conductive layer 27 is provided between the positive electrode active material layer 22b and the separator 23 so as to be arranged over a portion from a surface of the positive electrode active material layer 22b to the positive electrode current collector 22a. Here, the wording for the electrically conductive layer 27 “arranged over a portion from a surface of the positive electrode active material layer 22b to the positive electrode current collector 22a” means that both of the surface of the positive electrode active material layer 22b and the surface of the positive electrode current collector 22a include the electrically conductive layer 27 and are connected by the electrically conductive layer 27. The electrically conductive layer 27 herein is provided on the surface of the separator 23. In a form shown by FIG. 4, the electrically conductive layer 27 is provided on a first surface 23a of the separator 23. The first surface 23a is a surface arranged at the positive electrode 22 side. In this embodiment, the electrically conductive layer 27 is not provided on a second surface 23b of the separator 23. The second surface 23b is a surface at a side opposite to the first surface 23a, and a surface arranged at the negative electrode 24 side. In this embodiment, the electrically conductive layer 27 is configured to cover the positive electrode active material layer 22b and to cover a part of the positive electrode tab 22t. The electrically conductive layer 27 is joined to the positive electrode current collector 22a at the joint part W of the positive electrode current collector 22a (here, the positive electrode tab 22t) and the separator 23.

In this embodiment, the electrically conductive layer 27 is a metal layer. It is good that the electrically conductive layer 27 contains, for example, aluminum, titanium, stainless steel, nickel, or alloy of them, or consists of any of these metals. The electrically conductive layer 27 can be formed, for example, by making the separator 23 be subjected to a deposition, sputtering, plating, or the like. As a method for forming the electrically conductive layer 27, it is possible among them to preferably use a physical vapor deposition, such as vacuum deposition, an electroless plating, or the like. Incidentally, a thickness of the electrically conductive layer 27 is not particularly restricted, and might be set to be, for example, 10 nm to 1000 nm, or preferably 100 nm to 900 nm.

The positive electrode terminal 30 is a member that is electrically connected to the positive electrode 22 of the electrode assembly 20. As shown in FIG. 1 and FIG. 2, the positive electrode terminal 30 is attached to the sealing plate 14. As shown in FIG. 2, the positive electrode terminal 30 is attached to a right side of the sealing plate 14, and connected to the positive electrode tab 22t via the positive electrode current collector member 50. The positive electrode terminal 30 includes a positive electrode outside terminal 31 and a positive electrode inside terminal 32. As shown in FIG. 1 and FIG. 2, the positive electrode outside terminal 31 is formed in a plate shape, and arranged along an outer surface of the sealing plate 14. As shown in FIG. 2, the positive electrode inside terminal 32 includes a basal part 32a and a shaft part 32b. The basal part 32a is formed in a plate shape, and arranged along the outer surface of the sealing plate 14. The shaft part 32b is formed in a column shape, configured to extend from the basal part 32a in a vertical direction, and inserted into a penetration hole 31h of the positive electrode outside terminal 31 and the first terminal install hole 18 of the sealing plate 14. A lower end part of the shaft part 32b is further connected to the positive electrode current collector member 50. It is good that the positive electrode terminal 30 is, for example, made of aluminum.

The negative electrode terminal 40 is a member that is electrically connected to the negative electrode 24 of the electrode assembly 20. As shown in FIG. 1 and FIG. 2, the negative electrode terminal 40 is attached to the sealing plate 14. As shown in FIG. 2, the negative electrode terminal 40 is attached to a left side of the sealing plate 14 and connected to the negative electrode tab 24t via the negative electrode current collector member 60. It is good that the negative electrode terminal 40 is, for example, made of copper. Except for this, the negative electrode terminal 40 might be formed in a shape similar to the positive electrode terminal 30. Incidentally, reference signs “41” and “42” of FIG. 1 and FIG. 2 respectively represent “negative electrode outside terminal” and “negative electrode inside terminal”.

The positive electrode current collector member 50 is a member that is electrically connected to the positive electrode 22 of the electrode assembly 20. As shown in FIG. 2, the positive electrode current collector member 50 is attached to the sealing plate 14 and connected to the positive electrode terminal 30 and the positive electrode tab 22t. The positive electrode current collector member 50 includes a terminal connecting part 51 and a tab connecting part 52. The terminal connecting part 51 has a cross section formed in a L shape, and includes a portion arranged on an inner surface of the sealing plate 14 and a portion configured to extend along the vertical direction. A portion arranged at the inner surface of the sealing plate 14 is connected to the shaft part 32b of the positive electrode inside terminal 32. The portion configured to extend along the vertical direction is connected to the tab connecting part 52. The tab connecting part 52 is formed in a plate shape, and configured to extend along the vertical direction. The tab connecting part 52 is connected to the positive electrode tab 22t. It is good that the positive electrode current collector member 50 is, for example, made of aluminum.

The negative electrode current collector member 60 is a member that is electrically connected to the negative electrode 24 of the electrode assembly 20. As shown in FIG. 2, the negative electrode current collector member 60 is attached to the sealing plate 14 and connected to the negative electrode terminal 40 and the negative electrode tab 24t. It is good that the negative electrode current collector member 60 is, for example, made of copper. Except for this, the negative electrode current collector member 60 might be formed in a shape similar to the positive electrode current collector member 50. Incidentally, reference signs “61” and “62” in FIG. 2 respectively represent “terminal connecting part” and “tab connecting part”.

As shown in FIG. 2, an insulating member included by the energy storage device 100 contains a first insulating member 71, a second insulating member 72, and an insulation film (not shown in drawings). The first insulating member 71 herein is arranged between the positive electrode terminal 30 and the sealing plate 14, and arranged between the negative electrode terminal 40 and the sealing plate 14. The second insulating member 72 herein is arranged between the positive electrode current collector member 50 and the sealing plate 14, and arranged between the negative electrode current collector member 60 and the sealing plate 14. The insulation film (not shown in drawings) is a resin film configured to wrap the electrode assembly 20, and is configured to establish an insulation among the electrode assembly 20, the case 10, and the other metal members. As a material configuring various insulating members, it is possible without particular restriction to use an insulating property material (for example, a resin material) that has been conventionally used for this kind of the energy storage device.

The nonaqueous electrolytic solution contains, for example, a nonaqueous solvent and a supporting salt. As the nonaqueous solvent, it is possible to use various organic solvents, such as carbonates, ethers, esters, nitriles, sulfones, and lactones that are used for this kind of purpose. Among them, the carbonates are preferably used. As the carbonates, it is possible to use, for example, ethylene carbonate (EC), propylene carbonate (PC), diethyl carbonate (DEC), dimethyl carbonate (DMC), ethyl methyl carbonate (EMC), fluoro ethylene carbonate (FEC) (preferably, monofluoroethylene carbonate), monofluoromethyl difluoromethyl carbonate (F-DMC), trifluoro dimethyl carbonate (TFDMC), or the like. As the nonaqueous solvent, one kind of the nonaqueous solvent might be used alone, or two or more kinds of the nonaqueous solvents might be mixed so as to be used. As the supporting salt, it is possible to use, for example, a lithium salt, such as LiPF₆, LiBF₄, and LiClO₄. It is good that a concentration of the supporting salt is, for example, 0.7 mol/L to 1.4 mol/L. The nonaqueous electrolytic solution might, as needed, contain an additive agent that is used for this kind of purpose. As the additive agent, for example, it is possible to contain a coating layer forming agent, such as LiB(C₂O₄)₂(LiBOB) and LiBF₂(C₂O₄); a gas generation agent, such as biphenyl (BP) and cyclohexylbenzene (CHB); a thickening agent; or the like.

The energy storage device 100 can be used for various purposes. As a suitable usage, it is possible to apply it for a driving power supply mounted on a vehicle, such as battery electric vehicle (BEV), hybrid electric vehicle (HEV), and plug-in hybrid electric vehicle (PHEV). The energy storage device 100 can be used, for example, as a storage battery, such as small electric power storage device. The energy storage device 100 can be used, for example, in a form of a battery pack in which plural ones are connected in series and/or in parallel.

As described above, the energy storage device 100 includes the positive electrode 22, the negative electrode 24, the separator 23 configured to separate the positive electrode 22 and the negative electrode 24, and the electrically conductive layer 27. The positive electrode 22 includes the positive electrode current collector 22a and the positive electrode active material layer 22b that is provided on the positive electrode current collector 22a. The electrically conductive layer 27 is provided between the positive electrode active material layer 22b and the separator 23 to be arranged over a portion from the surface of the positive electrode active material layer 22b to the positive electrode current collector 22a.

The energy storage device 100 includes the electrically conductive layer 27 that is provided between the positive electrode active material layer 22b and the separator 23 to be arranged over a portion from the surface of the positive electrode active material layer 22b to the positive electrode current collector 22a. By this, it becomes possible to collect the current from the positive electrode active material layer 22b at both of the positive electrode current collector 22a and the electrically conductive layer 27. Thus, a current collector distance from the positive electrode active material layer 22b on the positive electrode 22 can be shortened, and therefore it is possible to enhance a current collecting efficiency.

An effect described above is preferable, for example, from a perspective for implementing a high energy density of the energy storage device 100. In a situation where the high energy density of the energy storage device 100 is required, it is possible to think, for example, thickening the positive electrode active material layer 22b. Although not particularly restricting, a thickness of the positive electrode active material layer 22b can be set to be approximately 10 μm to 300 μm. In a situation where the positive electrode active material layer 22b is thickened from a perspective of implementing the high energy density, the thickness of the positive electrode active material layer 22b is preferably 50 μm to 300 μm, or further preferably 100 μm to 300 μm.

The positive electrode current collector 22a might include a body part 22al formed in a rectangular sheet shape and include the positive electrode tab 22t configured to outwardly protrude from a first edge (here, a short edge) of the body part 22al. The electrically conductive layer 27 might be provided at the first edge side over a portion from the surface of the positive electrode active material layer 22b to the positive electrode tab 22t. The positive electrode tab 22t is, for example, a portion that is electrically connected to another member (here, the positive electrode current collector member 50). By providing the electrically conductive layer 27 over a portion from the surface of the positive electrode active material layer 22b to the positive electrode tab 22t, it is possible to enhance a connectivity from the positive electrode 22 to another member, in addition to the above described effect. Regarding the above described configuration, the electrode assembly 20 containing the positive electrode 22 might be a laminate electrode assembly. By this, it is possible to enhance a productivity of the energy storage device 100.

On a surface of the separator 23, the electrically conductive layer 27 might be provided. Regarding the above described aspect, as the separator, it is sufficient to prepare the separator 23 on which the electrically conductive layer 27 is provided, and thus it is possible to further easily use an existing manufacture line for manufacturing the energy storage device 100. In addition to this, it is not easy for a material of the electrically conductive layer 27 to adhere on the positive electrode active material, and thus it is possible to further easily recycle the positive electrode active material.

The electrically conductive layer 27 might be joined to the positive electrode current collector 22a. By joining the electrically conductive layer 27 and the positive electrode current collector 22a so as to integrate them, the effect of the herein disclosed technique can be further properly implemented.

The electrically conductive layer 27 might be a metal deposition layer. By this, for example, it is possible to further surely integrate the separator 23 and the electrically conductive layer 27, and thus it is possible to further properly reduce a risk of the electrically conductive layer 27 being peeled off from the separator 23 at the manufacture process. Therefore, the above described aspect is preferable to implement the effect of the herein disclosed technique.

Above, the embodiment of the herein disclosed technique has been explained. Incidentally, in the above described embodiment, an example to which the herein disclosed technique is applied is shown, and it is not to restrict the herein disclosed technique.

### Second Embodiment

For example, in the first embodiment, the separator 23 has been used on which the electrically conductive layer 27 has been provided. However, the electrically conductive layer is not restricted to a condition of being provided on the separator. FIG. 5 is a partial cross section view of an electrode assembly 220. FIG. 5 schematically shows a laminate structure of the electrode at a vicinity of the positive electrode tab 222t on the electrode assembly 220. FIG. 5 omits showing the negative electrode in the drawing. As shown in FIG. 5, the electrode assembly 220 includes a positive electrode 222, a negative electrode, and a separator 223 that is configured to separate the positive electrode 222 and the negative electrode. The electrode assembly 220 herein is a laminate electrode assembly. The positive electrode 222 includes a positive electrode current collector 222a and a positive electrode active material layer 222b. The positive electrode current collector 222a might be the same as the above described positive electrode current collector 22a (see FIG. 3 and FIG. 4). The positive electrode active material layer 222b might be the same as the above described positive electrode active material layer 22b (see FIG. 3 and FIG. 4). The separator 223 might be the same as the above described separator 23 (see FIG. 3 and FIG. 4).

In a form shown by FIG. 5, the electrically conductive layer 227 is provided on a surface of the positive electrode active material layer 222b. The electrically conductive layer 227 herein is provided on the surface of the positive electrode active material layer 222b. In this embodiment, the electrically conductive layer 227 is provided on an end face 222b1 of the positive electrode active material layer 222b in the thickness direction, on a side surface 222b2 along the same direction, and on a surface of a part of the positive electrode current collector 222a (herein, a surface of a part of the positive electrode tab 222t).

It is good that the electrically conductive layer 227 is, for example, a metal layer. It is good that the electrically conductive layer 227 might contain, for example, aluminum, titanium, stainless steel, nickel, or alloys of them, or might consist of any of these metals. The electrically conductive layer 227 can be formed, for example, by making surfaces of parts of the positive electrode active material layer 222b and the positive electrode current collector 222a be subjected to the deposition, sputtering, plating, or the like. As a method for forming the electrically conductive layer 227, it is possible among them to preferably use a physical vapor deposition, such as vacuum deposition, an electroless plating, or the like. Incidentally, a thickness of the electrically conductive layer 227 is not particularly restricted, and might be set to be, for example, 10 nm to 1000 nm, or preferably 100 nm to 900 nm.

As described above, the electrically conductive layer 227 might be provided on the surface of the positive electrode active material layer 222b. In the aspect described above, it is possible to properly implement the effect of the herein disclosed technique. Further, by providing the electrically conductive layer 227 on the surface of the positive electrode active material layer 222b, it is possible to enhance a closely bonded property of the electrically conductive layer 227 and the positive electrode active material layer 222b, and thus it is preferable.

The electrically conductive layer 227 might cover at least a part of an end face 222b1 of the positive electrode active material layer 222b in the thickness direction and at least a part of a side surface 222b2 along the same direction. By this, it is possible to enlarge an area where the electrically conductive layer 227 and the positive electrode active material layer 222b come into contact with each other. Therefore, the effect of the herein disclosed technique can be further easily implemented.

### Another Embodiment

In the above described embodiment, the electrically conductive layer has been provided at the positive electrode side. However, the herein disclosed technique is not restricted to this. The electrically conductive layer might be provided at the negative electrode side, instead of the positive electrode side or in addition to the positive electrode side. In a situation where the electrically conductive layer is provided at the negative electrode side, it is preferable that the metal being contained in the electrically conductive layer or configuring the electrically conductive layer is, for example, copper, nickel, or alloys of them. A method for providing the electrically conductive layer at the negative electrode side might be the same as the method for providing the electrically conductive layer at the positive electrode side.

In the above described embodiment, the laminate electrode assembly has been used. However, the herein disclosed technique is not restricted to this. The herein disclosed energy storage device might include, for example, a wound electrode assembly. The wound electrode assembly is an electrode assembly configured by making the long sheet-shaped positive electrode and the long sheet-shaped negative electrode be wound in the sheet longitudinal direction while the long sheet-shaped separator is disposed between them. Regarding the wound electrode assembly, it is good that the electrically conductive layer is provided between the separator and the positive electrode active material layer and/or negative electrode active material layer. The electrically conductive layer might be provided on the surface of the separator, or might be provided on the positive electrode active material layer and/or negative electrode active material layer and on the current collector.

Below, a test example related to the herein disclosed technique would be explained, but is not intended to restrict the herein disclosed technique into the below described test example.

### [Manufacture of Test Cell]

### Practical Example

It was performed to prepare LiNi_{1/3}Co_{1/3}Mn_{1/3}O₂ (LNCM) as the positive electrode active material, acetylene black (AB) as the electrically conducting material, and polyvinylidene fluoride (PVdF) as the binder. They were mixed with N-methylpyrrolidone (NMP) at a mass ratio being LNCM:AB:PVdF=92:5:3, so as to manufacture a positive electrode slurry. The positive electrode slurry was applied to cover both surfaces of an aluminum foil being formed in a rectangular sheet shape whose thickness was 15 μm, dried, and then pressed to have a predetermined thickness. By processing this to have a predetermined size and attaching the positive electrode tab (an aluminum piece) to this, the positive electrode sheet was obtained.

It was performed to prepare the graphite particle as the negative electrode active material, the styrene butadiene rubber (SBR) as the binder, and the carboxymethyl cellulose (CMC) as the thickening agent. These were mixed with an ion exchange water at a mass ratio being graphite particle/SBR/CMC=99:0.5:0.5, so as to manufacture a negative electrode slurry. The negative electrode slurry was applied to cover one surface of a copper foil being formed in the rectangular sheet shape whose thickness was 10 μm, dried, and then pressed to have a predetermined thickness. By processing this to have a predetermined size and attaching the negative electrode tab (a copper piece) to this, the negative electrode sheet was obtained.

As a base material of the separator, two porous polyolefin sheets (thickness 20 μm), each of which had a three-layers structure of PP/PE/PP, were prepared. On one surface of each of these two sheets, a vacuum deposition with aluminum was performed by a vacuum deposition equipment of ULVAC, Inc., so as to provide the electrically conductive layer (an aluminum deposition layer). Then, the positive electrode sheet was interposed between electrically conductive layer formed surfaces of these two separators. At that time, a tip end of the positive electrode tab was configured to protrude from the separator. Next, the separator and a base end of the positive electrode tab were joined by the ultrasonic welding, so as to obtain a combined product of the separator and the positive electrode sheet. Next, each negative electrode sheet was mounted on the separator being the combined product (here, on the electrically conductive layer formed surface and on the surface at the opposite side), so as to obtain the electrode assembly. Regarding the electrode assembly obtained herein, the positive electrode sheet whose both surfaces were provided with the positive electrode active material layers were interposed by two negative electrode sheets, each of which is provided with the negative electrode active material layer on one surface, while the separator with the electrically conductive layer was disposed between them.

The electrode assembly was inserted into an outer case being an aluminum laminate sheet, the nonaqueous electrolytic solution was injected, and then the opening of the outer case was sealed, so as to manufacture a test cell of a practical example. A composition (a volume ratio) of the nonaqueous electrolytic solution was EC/DMC/EMC=30:30:40. Into the nonaqueous electrolytic solution, LiPF₆ as the supporting salt was dissolved at a concentration being 1 mol/L.

### Comparative Example

As the separator, a separator base material was used in which the electrically conductive layer was not provided. Except for that, a material and a procedure which were the same as the practical example were used, so as to manufacture the test cell of a comparative example.

### [Measurement of Initial Capacity]

On the test cell, 1 cycle of an electrical charge and discharge cycle was performed under 25° C. environment, as a constant electrical current charge (a CC charge) was performed at an electrical charge rate being 0.05 C until an electrical voltage between the positive electrode and the negative electrode reached 4.2 V and then a constant electrical current discharge (a CC discharge) was performed at an electric discharge rate being 0.05 C until the electrical voltage between the positive electrode and the negative electrode reached 2.5 V in the electrical charge and discharge cycle. An electrical discharge capacity at that time was measured so as to be treated as an initial capacity.

### [Output IV Resistance Evaluation]

The test cell whose SOC was treated as 100% was kept in a thermostatic chamber at 25° C., the SOC was adjusted to be 50%, and then the electrical discharge was performed at each of electrical current values being 1 C, 1.5 C, 2 C, and 3 C in that adjusted state for 10 seconds. A cell electrical voltage was measured when the electrical discharge was performed at each electrical current value, each electrical current value and each cell electrical voltage were plotted, an I-V characteristic at an electrically discharging time was obtained, and then an IV resistance at the electrically discharging time was obtained on a basis of an inclination of the obtained straight line. A result is shown on an applicable column of Table 1. Incidentally, the result shown in Table 1 is a relative value when a calculation value of the comparative example is treated as 100.

TABLE 1

| | Electrically conductive | Output IV |
|---|---|---|
| | layer | resistance |
| Practical example | Presence | 92 |
| Comparative example | Absence | 100 |

As shown in Table 1, an IV resistance of the practical example at the electrically discharging time was lower than the IV resistance of the comparative example at the electrically discharging time. The test cell of the practical example includes the positive electrode, which includes the positive electrode current collector and the positive electrode active material layer provided on the positive electrode current collector, includes the negative electrode, includes the separator configured to separate the positive electrode and the negative electrode, and the electrically conductive layer. The electrically conductive layer is provided between the positive electrode active material layer and the separator so as to be arranged over a portion from the surface of the positive electrode active material layer to the positive electrode current collector. Based on the result obtained from the above described test example, it was found that, by the above described configuration, an current collecting efficiency on the positive electrode is enhanced.

The herein disclosed technique could contain techniques recited in below-described Items.
Item 1:
An energy storage device, comprising:
   a first electrode that comprises a first current collector and a first active material layer provided on the first current collector;
   a second electrode;
   a separator that is configured to separate the first electrode and the second electrode; and
   an electrically conductive layer that is provided between the first active material layer and the separator so as to be arranged over a portion from a surface of the first active material layer to the first current collector.
Item 2:
The energy storage device recited in Item 1, wherein
   the first current collector comprises a body part formed in a rectangular sheet shape and a first tab configured to protrude outwardly from a first edge of the body part, and
   the electrically conductive layer is provided, at a side of the first edge, over a portion from the surface of the first active material layer to the first tab.
Item 3:
   The energy storage device recited in Item 1 or 2, wherein
      the electrically conductive layer is provided on a surface of the separator.
Item 4:
The energy storage device recited in any one of Items 1 to 3, wherein the electrically conductive layer is joined to the first current collector.
Item 5:
The energy storage device recited in any one of Items 1 to 4, wherein
   the electrically conductive layer is provided on a surface of the first active material layer.
Item 6:
The energy storage device recited in any one of Items 1 to 5, wherein
   the electrically conductive layer is configured to cover at least a part of an end face of the first active material layer in a thickness direction and at least a part of a side surface along the thickness direction.
Item 7:
The energy storage device recited in any one of Items 1 to 6, wherein
   the electrically conductive layer is a metal deposition layer.

Above, embodiments of the herein disclosed technique have been explained, but these are merely illustrations, and are not construed as limiting the scope of the appended claims. The technique recited in claims contains matters in which the above-illustrated specific examples are variously deformed or changed.

1. An energy storage device, comprising:
a first electrode that comprises a first current collector and a first active material layer provided on the first current collector;
a second electrode;
a separator that is configured to separate the first electrode and the second electrode; and
an electrically conductive layer that is provided between the first active material layer and the separator so as to be arranged over a portion from a surface of the first active material layer to the first current collector.

2. The energy storage device according to claim 1, wherein
the first current collector comprises a body part formed in a rectangular sheet shape and a first tab configured to protrude outwardly from a first edge of the body part, and
the electrically conductive layer is provided, at a side of the first edge, over a portion from the surface of the first active material layer to the first tab.

3. The energy storage device according to claim 1, wherein
the electrically conductive layer is provided on a surface of the separator.

4. The energy storage device according to claim 3, wherein
the electrically conductive layer is joined to the first current collector.

5. The energy storage device according to claim 1, wherein
the electrically conductive layer is provided on a surface of the first active material layer.

6. The energy storage device according to claim 5, wherein
the electrically conductive layer is configured to cover at least a part of an end face of the first active material layer in a thickness direction and at least a part of a side surface along the thickness direction.

7. The energy storage device according to claim 1, wherein
the electrically conductive layer is a metal deposition layer.
